(19) United States
(12) Patent Application Publication
(10) Pub. No.: US 2025/0353041 A1
(43) Pub. Date: Nov. 20, 2025

(54) WASHING VESSEL FOR ARRESTOR FROM OIL AND GAS HEATER TREATER AND METHOD OF USE

(71) Applicant: Derek Allen, Midland, TX (US)

(72) Inventor: Derek Allen, Midland, TX (US)

(21) Appl. No.: 18/666,201

(22) Filed: May 16, 2024

(51) Int. Cl. B08B 3/02; B05B 3/02

(52) U.S. Cl. CPC B08B 3/024; B05B 3/02; B08B 2203/0211

(57) ABSTRACT

A flame arrestor washing assembly that includes a vessel portion having a floor, a lid, opposing first and second side walls, a front wall and a rear wall that cooperate to define a vessel interior, a drawer member received in a front opening of the vessel portion that is movable between a closed position and an open position, a nozzle assembly depending downwardly from a lower surface of the lid, and a source of washing liquid in liquid communication with the nozzle assembly. The drawer member includes a bottom member having a plurality of drain openings defined therein and is sized to receive a flame arrestor on the bottom member. The nozzle assembly is configured to spray washing liquid toward the flame arrestor positioned on the bottom member of the drawer member.

### FIELD OF THE INVENTION

The present invention relates to a washing vessel for a flame arrestor that is used in an oil and gas heater treater.

### BACKGROUND OF THE INVENTION

Oil and gas heater treaters include a flame arrestor therein. After prolonged use the arrestor can become dirty, which may lead to issues that can be catastrophic to the heater treater and the pipes therein.

The background description disclosed anywhere in this patent application includes information that may be useful in understanding the present invention. It is not an admission that any of the information provided herein is prior art or relevant to the presently claimed invention, or that any publication specifically or implicitly referenced is prior art.

### SUMMARY OF THE PREFERRED EMBODIMENTS

In accordance with a preferred embodiment of the present invention there is provided a flame arrestor washing assembly that includes a vessel portion having a floor, a lid, opposing first and second side walls, a front wall and a rear wall that cooperate to define a vessel interior, a drawer member received in a front opening of the vessel portion that is movable between a closed position and an open position, a nozzle assembly depending downwardly from a lower surface of the lid, and a source of washing liquid in liquid communication with the nozzle assembly. The drawer member includes a bottom member having a plurality of drain openings defined therein and is sized to receive a flame arrestor on the bottom member. The nozzle assembly is configured to spray washing liquid toward the flame arrestor positioned on the bottom member of the drawer member.

The lid may be pivotally connected to at least one of the first and second side walls, front wall or rear wall and may be movable between an open position and a closed position. The lid preferably defines a vertically oriented nozzle axis and the nozzle assembly includes a conduit member that is rotatable about the nozzle axis. The conduit member may include at least first and second arms. The first arm includes a first nozzle member and the second arm includes a second nozzle member. The first and second nozzle members are configured to spray washing liquid toward the flame arrestor positioned on the bottom member of the drawer. A vertical plane that includes first and second opposing sides may bifurcate the first and second arms. The first nozzle member may be configured to spray washing liquid from the first side of the vertical plane and the second nozzle member may be configured to spray washing liquid from the second side of the vertical plane.

The first nozzle member preferably defines a first exit conduit in liquid communication with the conduit member. The first exit conduit defines a first exit axis. The second nozzle member preferably defines a second exit conduit in liquid communication with the conduit member. The second exit conduit preferably defines a second exit axis. The first exit access may define a first orientation angle with the first side of the vertical plane. The first orientation angle may be between about 25° and about 35°. The second exit access may define a second orientation angle with the second side of the vertical plane. The second orientation angle may be between about 25° and about 35°. The first nozzle member may define a first spray angle that is between about 40° and about 60°, and the second nozzle member may define a second spray angle that is between about 40° and about 60°. The lid may include a liquid opening defined therein and a washing liquid path may be defined from the source of washing liquid through the liquid opening in the lid and into the conduit member.

In accordance with another aspect of the present invention there is provided a method of cleaning a flame arrestor that includes obtaining a flame arrestor washing assembly, moving the drawer member from the open position to the closed position, and flowing washing liquid from the source of washing liquid to the nozzle assembly at a first washing liquid pressure and a first washing liquid temperature. The first washing liquid pressure is between about 1500 PSI and 2000 PSI. The first washing liquid temperature is between about 140° and about 200°. As a result, the nozzle assembly rotates and washing liquid is sprayed from the nozzle assembly to the flame arrestor.

The flame arrestor is a specialized component in an oil and gas heater treater that controls the air flow in the first tube to allow the flame to burn efficiently. The arrestor may be washed periodically to prevent buildup of materials therein that may cause air flow issues and may result in increases the chance of fire or explosion in the heater treater fire tube. The flame arrestor may include fins, screens, perforated plates, and/or slots that are enclosed in a frame and other parts that may be subject to damage. The fins, screen, perforated plates, etc. allow air to travel through the arrestor. If the openings that provide air flow are clogged by dirt, gunk, etc. catastrophic failure may result. For example, an implosion may occur in the U-shaped fire tube, which includes the burner on one side and exhaust on the other. The flame arrestor controls the air flow in the fire tube so that the fire tube does not include too much air to put the flame out, but enough air to allow the flame to burn efficiently. If too much dirt or gunk fills the flame arrestor and prevents airflow therethrough, the pressure can build up in the tube and cause an implosion or other issue.

With a high pressure wash, as is provided in the present invention, if the pressure is too much, the fins and the like may be bent by the water or cleaning liquid sprayed thereon. This can cause issues as the bent fins will block the airflow therethrough, which can be worse than dirt buildup blocking the airflow. Therefore, a washing vessel may be used to wash the arrestor, but without causing damage thereto. The angle of the nozzles with respect to vertical is preferably about 20° with a 40° to 60° spread of the actual water or liquid coming out of the nozzle member opening (i.e., the “V” shape of the water or washing liquid coming out of the nozzle). It will be appreciated that a less than 40° spread can cause damage to the fins. An over 60° spread is not strong enough to properly clean the flame arrestor and/or the fins.

### BRIEF DESCRIPTION OF THE DRAWINGS

FIG. 1 is a perspective view of a flame arrestor washing assembly in accordance with a preferred embodiment of the present invention;

FIG. 2 is a perspective view of the vessel portion with the drawer member in the open position;

FIG. 3 is a perspective view of the vessel portion with the lid in the open position;

FIG. 4A is a side elevational view of the nozzle assembly and showing the first nozzle member;

FIG. 4B is a side elevational view of the second nozzle member with a cut through the conduit member taken along line 4B--4B of FIG. 3;

FIG. 5 is a front elevational cross-section of the vessel portion taken along line 5--5 of FIG. 1;

FIG. 6 is a perspective view of a heater treater that includes a flame arrestor.

FIG. 7 is a perspective view of a flame arrestor;

FIG. 7A is a detail view of the a portion of the flame arrestor;

FIG. 8 is a perspective view of another embodiment of a washing assembly; and

FIG. 9 is another perspective view of the washing assembly of FIG. 7 with a flame arrestor therein.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are references to the same embodiment; and, such references mean at least one of the embodiments. If a component is not shown in a drawing then this provides support for a negative limitation in the claims stating that that component is “not” present. However, the above statement is not limiting and in another embodiment, the missing component can be included in a claimed embodiment.

Reference in this specification to “one embodiment,” “an embodiment,” “a preferred embodiment” or any other phrase mentioning the word “embodiment” means that a particular feature, structure, or characteristic described in connection with the embodiment is included in at least one embodiment of the-disclosure and also means that any particular feature, structure, or characteristic described in connection with one embodiment can be included in any embodiment or can be omitted or excluded from any embodiment. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others and may be omitted from any embodiment. Furthermore, any particular feature, structure, or characteristic described herein may be optional. Similarly, various requirements are described which may be requirements for some embodiments but not other embodiments. Where appropriate any of the features discussed herein in relation to one aspect or embodiment of the invention may be applied to another aspect or embodiment of the invention. Similarly, where appropriate any of the features discussed herein in relation to one aspect or embodiment of the invention may be optional with respect to and/or omitted from that aspect or embodiment of the invention or any other aspect or embodiment of the invention discussed or disclosed herein.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

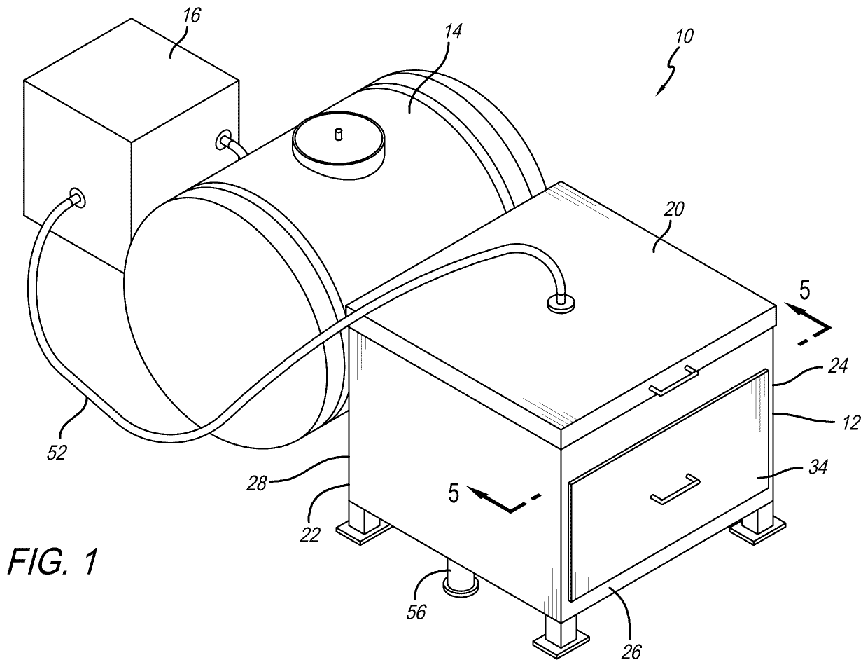

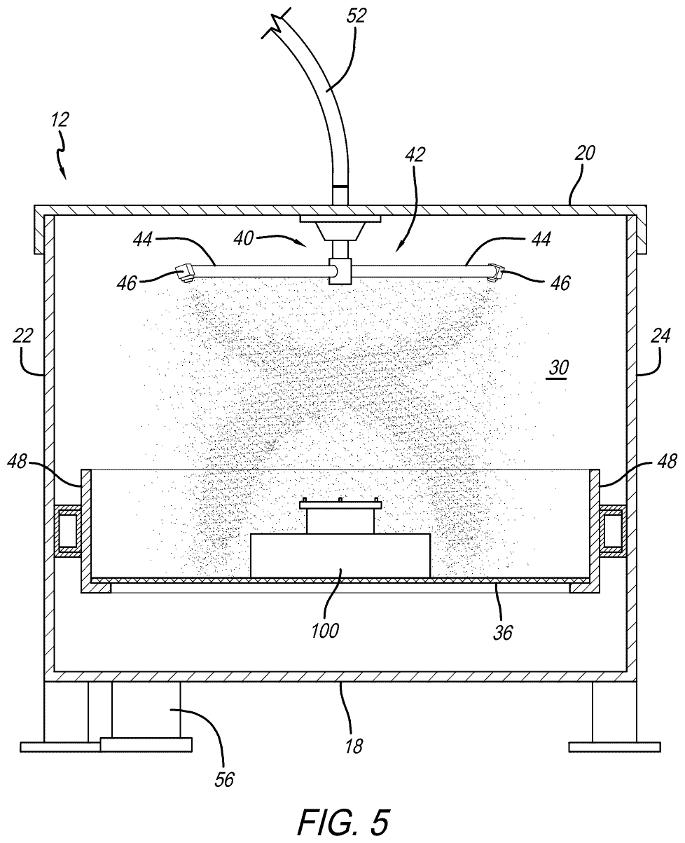

As shown in FIGS. 1-5, the present invention is a washing assembly 10 that is used for washing flame arrestors 100 that are used in heater treaters in the oil and gas industry. Generally, the present invention includes a vessel portion 12, a source of water or washing liquid source 14, such as a tank or other container, and a motor 16. FIG. 1 shows the vessel portion 12, source of washing liquid or washing liquid source 14 and motor 16 as separate components. However, in another embodiment they may be incorporated into one unit or assembly. The washing liquid may be water, water and soap, water combined with other liquids or any type of liquid used for washing. The washing liquid source (water storage) and motor may be combined in one unit or be separate units that provide pressure washing.

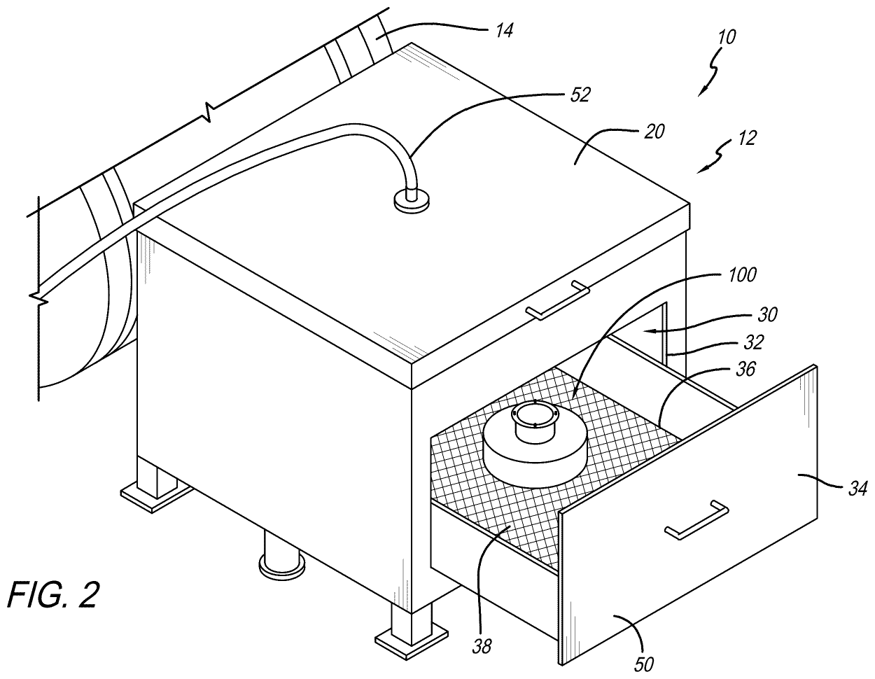

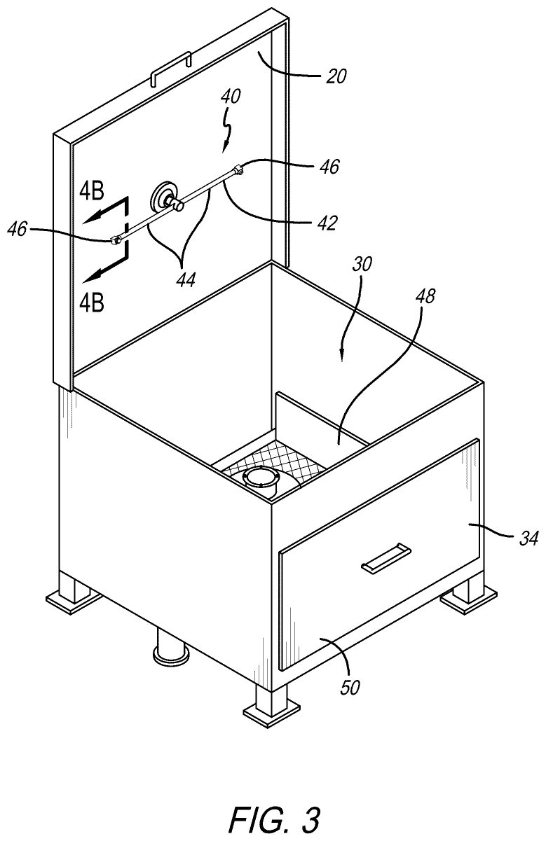

As shown FIGS. 2 and 3, the vessel portion 12 may include a floor 18, a lid 20, opposing first and second side walls 22 and 24, a front wall 26 and a rear wall 28 that cooperate to define a vessel interior 30. The front wall 26 preferably includes a front opening 32 defined therein that receives a drawer member 34 and that is movable between a closed position (FIG. 3) and an open position (FIG. 2). The drawer member 34 includes a bottom member 36 that may have a plurality of drain openings 38 defined therein. As shown in FIG. 2, the bottom member 36 may be a mesh or grate material that includes the drain openings 38 defined therein. In use, the flame arrestor 100 is placed on the bottom member 36.

In a preferred embodiment, the lid 20 is pivotally connected to at least one of the first and second side walls 22 and 24, front wall 26 or rear wall 28 and is movable between an open position (FIG. 3) and a closed position (FIG. 2). FIG. 3 shows the lid 20 pivotally connected to the rear wall 28. The lid 20 may also be removable without being connected to any of the walls. In a preferred embodiment, a nozzle assembly 40 depends downwardly from a lower surface 20a of the lid. The nozzle assembly 40 is configured to spray washing liquid toward the flame arrestor 100 positioned on the bottom member 36 of the drawer member 34.

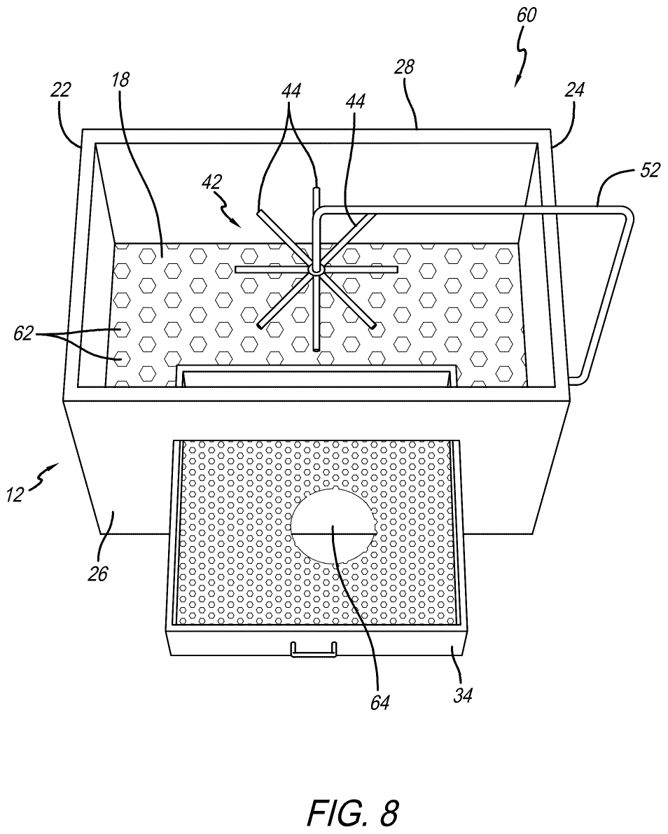

In a preferred embodiment, the lid defines a vertically oriented nozzle axis A1 and the nozzle assembly 40 includes a conduit member 42 that is rotatable about the nozzle axis A1. The conduit member 42 preferably includes a plurality of arms 44 through which washing liquid can flow. The embodiment of FIG. 3 shows the conduit member 42 having two or first and second arms 44 that extend outwardly from the nozzle axis. The embodiment shown in FIG. 8, discussed further below, includes eight arms. Each arm 44 includes a nozzle member 46 thereon, preferably at or near the distal end of the arm. The nozzle members 46 are configured to spray washing liquid toward the flame arrestor 100 and the bottom member 36 of the drawer member 34. As shown in FIG. 2, the drawer member 34 may also include side walls 48 and a front wall 50 that covers the front opening 32 in the front wall 26 of the vessel portion 12. The washing liquid may exit the vessel interior 30 through a drain 56 (see FIG. 1).

FIG. 1 shows the washing liquid source 14 and motor 16 (simplified as a box) separate from the vessel portion 12 and that includes a series of conduits or hoses 52 that extend between the components. This is only used as an example. It will be appreciated that the washing liquid is directed to the vessel portion 12 and is sprayed through the nozzle members to wash or clean the flame arrestor. Ultimately, the washing liquid source or tank is in liquid communication with the nozzle assembly 40. Any system for directing pressurized washing liquid to and out of the nozzle members is within the scope of the present invention. Hose 52 is preferably connected to lid 20, which may include a liquid opening 54 therein that allows water to go from the hose, through the lid and into the nozzle assembly.

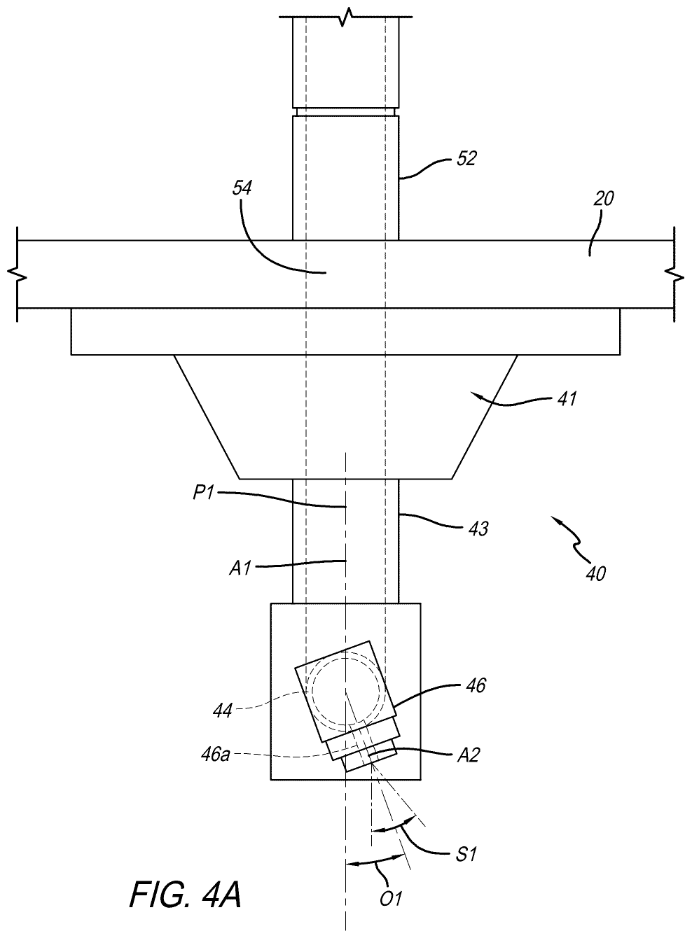

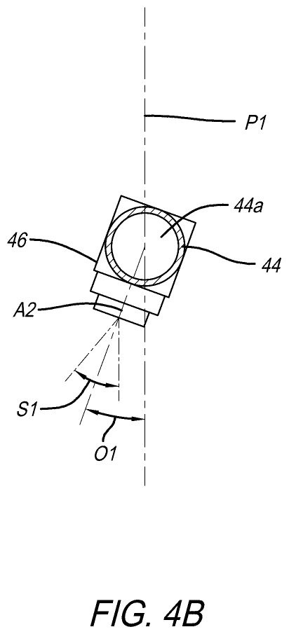

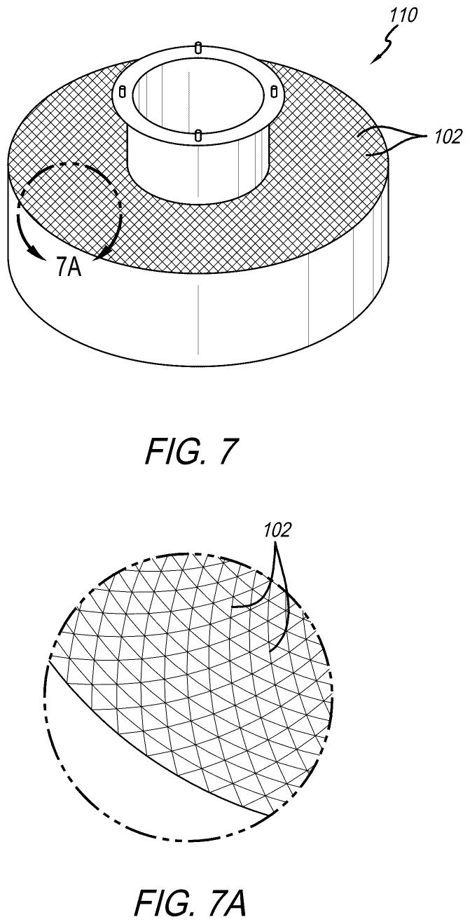

In a preferred embodiment, the nozzle assembly 40 is configured so that the pressure of the water exiting the nozzle members 46 causes the conduit member 42 to rotate. The nozzle assembly 40 may include a rotation assembly 41 that includes a rod 43 that connects to the conduit member 42 and rotates together therewith. The rod 43 includes a portion of the water path therein or therethrough. FIGS. 4A and 4B show a preferred orientation of the first and second nozzle members 46 and the angles related thereto for optimized washing of the flame arrestor 100. It will be appreciated that flame arrestors 100 include delicate components that may be damaged if too much water or liquid pressure is applied thereto. At the same time, the material that may build up on the flame arrestor during use is difficult to remove. Therefore, the dimensions and angles discussed herein are optimized to provide cleaning of the flame arrestor while not damaging components. FIGS. 7 and 7A show an exemplary flame arrestor 100. The flame arrestor 100 includes fins 102 that can be easily bent if too much direct pressure is applied. The inventor has found that an orientation angle O1, as shown in FIGS. 4A and 4B with respect to the vertical of about 20° is optimal to provide cleaning and not bend the fins.

As shown in FIGS. 4A and 4B, a vertical plane P1 bifurcates the first and second arms 44. The orientation of the nozzle members 46 with respect to the vertical plane P1 affects the pressure and volume of washing liquid contacting the flame arrestor 100. The vertical plane P1 includes first and second opposing sides and the first nozzle member 40 is configured to spray washing liquid from the first side of the vertical plane P1 (FIG. 4A) and the second nozzle member 40 is configured to spray washing liquid from the second side of the vertical plane P1 (FIG. 4B).

As shown in FIGS. 4A and 4B, the arms 44 include an arm interior 44a and the nozzle members 46 include an exit conduit 46a that is in liquid communication with the conduit member or arm(s). The exit conduit 46a defines an exit axis A2. The exit access A2 defines an orientation angle O1 with the vertical plane P1. In a preferred embodiment, the orientation angle O1 is about 20°. In a preferred embodiment, the orientation angle may be between about 5° and about 50°. In another preferred embodiment, the orientation angle may be between about 10° and about 35°. In another preferred embodiment the orientation angle may be between about 15° and about 25°. In an exemplary embodiment, the orientation angle is about 20°. As shown in FIG. 4B, the other nozzle member 40 (or second nozzle member) also includes the exit axis A2, which defines the orientation angle O1 with the vertical plane P1 (or with respect to the other side of the vertical plane P1. The ranges described above for the first nozzle member 40 are applicable to the second nozzle member. Preferably, the orientation angle of both of the nozzle members is the same, but facing in the opposite direction (or with respect to opposite sides of the vertical plane).

The nozzle members 46 also include a spread angle S1 that is between about 40° to about 60°. This is the actual spread of the water or liquid coming out of the nozzle member opening (i.e., the “V” shape of the water or washing liquid coming out of the nozzle). It will be appreciated that a less than 40° spread can cause damage to the fins. An over 60° spread is not strong enough to properly clean the flame arrestor and/or the fins. The operability or effectiveness of the orientation and spread angles also may be dependent on the water pressure or washing liquid pressure and temperature. In a preferred embodiment, the washing liquid pressure may be between about 1000 PSI and about 2500 PSI. In another preferred embodiment, the washing liquid pressure may be between about 1500 PSI and about 2000 PSI. In another preferred embodiment, the washing liquid pressure may be between about 1700 PSI and about 1800 PSI.

In a preferred embodiment, the water or washing liquid is also heated, preferably to a temperature to produce steam to help with the cleaning process. In particular, with the heat helps remove the oil and grime build up on and/or in the flame arrestor. In a preferred embodiment, the washing liquid temperature may be between about 140° and about 200°. In another preferred embodiment, the orientation angle may be between about 170° and about 190°. In an exemplary embodiment, the washing liquid temperature is about 180°.

It will be appreciated that the water or washing liquid follows a path from the water source 14 until it exits the nozzle members 46. The path may change, but, in an example, the washing liquid path is defined from the source of washing liquid, through the liquid opening in the lid, to the conduit member, through the arms (the arm interiors), through the nozzle members (the exit conduit) and out the nozzle or exit opening, whereby it's sprayed into the vessel interior and to the flame arrestor.

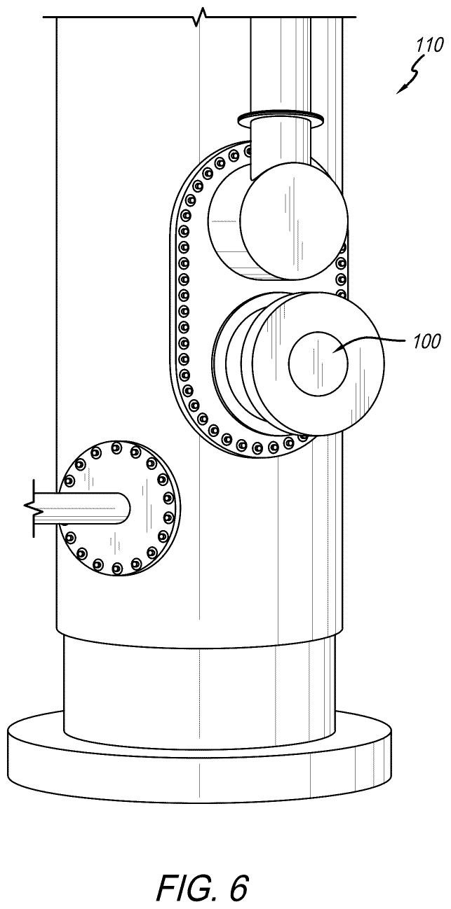

FIG. 6 shows an exemplary heater treater 110 that includes a flame arrestor 100 therein. The flame arrestor 100 is behind a plate in FIG. 6. In use, the flame arrestor 100 is removed from the heater treater 110, the drawer member 34 is moved from the closed position to the open position, the flame arrestor 100 is positioned on the bottom of the drawer member 34, and the drawer member 34 is moved from the open position to the closed position. The washing assembly 10 is then turned on so that the washing liquid is pumped or moved from the water or washing liquid source 14 (via the motor 16) and the washing liquid follows the washing liquid path and is sprayed onto the flame arrestor 100. As discussed above, the washing liquid specifications or variables as it exits the nozzle assembly is considered so that the flame arrestor 100, and the fins 102 or other components thereof, are not damaged.

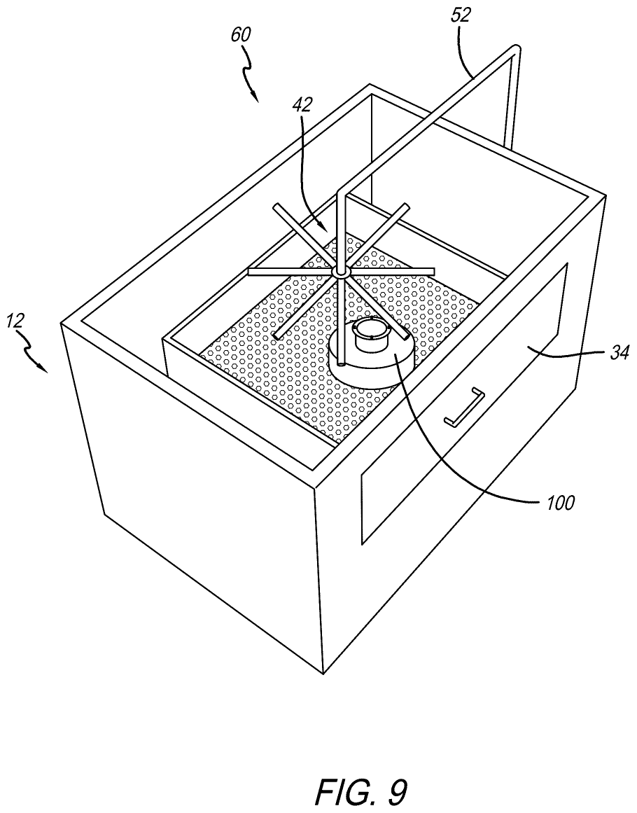

FIGS. 8-9 show another embodiment of a washing assembly 60 that includes the water source 14, motor 16 and other components in the bottom of the vessel interior 30 below the drawer member 34. See the conduit or hose 52 that extends from the bottom of the vessel portion 12 up to the top and into the vessel interior. The lid is omitted in FIGS. 8 and 9. The conduit member 42 includes eight arms 44 and may be rotatable or may include nozzle members that spray at a predetermined angle. The floor 18 also includes drain openings 62 therein so that the washing liquid flows to a drain thereunder. The bottom member 36 of the drawer member 34 may include a flame arrestor opening 64 that allows the flame arrestor 100 to be seated therein so that it is properly positioned with respect to the geometry of washing liquid spray.

In use, the plate that covers the flame arrestor is removed and the flame arrestor 100 is removed from its normal position in the opening in the heater treater 110, the drawer member 34 is moved from the closed to the open position and the flame arrestor 100 is placed on the bottom member 36. The drawer member 36 is then moved back to the closed position. If the lid 20 is in the open position, it is moved to the closed position. The washing assembly 10 is then started with the activation of the motor, the washing liquid follows the washing liquid path is sprayed onto and around the flame arrestor to wash the flame arrestor.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. Further, any specific numbers noted herein are only examples: alternative implementations may employ differing values, measurements or ranges.

Although the operations of any method(s) disclosed or described herein either explicitly or implicitly are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

The teachings of the disclosure provided herein can be applied to other systems, not necessarily the system described above. The elements and acts of the various embodiments described above can be combined to provide further embodiments. Any measurements or dimensions described or used herein are merely exemplary and not a limitation on the present invention. Other measurements or dimensions are within the scope of the invention.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, ¶6, other aspects may likewise be embodied as a means-plus-function claim, or in other forms, such as being embodied in a computer-readable medium. (Any claims intended to be treated under 35 U.S.C. § 112, ¶6 will include the words “means for”). Accordingly, the applicant reserves the right to add additional claims after filing the application to pursue such additional claim forms for other aspects of the disclosure.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A flame arrestor washing assembly comprising:
a vessel portion that includes a floor, a lid, opposing first and second side walls, a front wall and a rear wall that cooperate to define a vessel interior, wherein the front wall includes a front opening defined therein,
a drawer member that is received in the front opening and that is movable between a closed position and an open position, wherein the drawer member includes a bottom member having a plurality of drain openings defined therein, and wherein the drawer member is sized to receive a flame arrestor on the bottom member,
a nozzle assembly depending downwardly from a lower surface of the lid, wherein the nozzle assembly is configured to spray washing liquid toward the flame arrestor positioned on the bottom member of the drawer member, and
a source of washing liquid in liquid communication with the nozzle assembly.

2. The flame arrestor washing assembly of claim 1 wherein the lid is pivotally connected to at least one of the first and second side walls, front wall or rear wall and is movable between an open position and a closed position.

3. The flame arrestor washing assembly of claim 2 wherein the lid defines a vertically oriented nozzle axis, wherein the nozzle assembly includes a conduit member that is rotatable about the nozzle axis, wherein the conduit member includes at least first and second arms, wherein the first arm includes a first nozzle member and the second arm includes a second nozzle member, and wherein the first and second nozzle members are configured to spray washing liquid toward the flame arrestor positioned on the bottom member of the drawer.

4. The flame arrestor washing assembly of claim 3 wherein a vertical plane bifurcates the first and second arms, wherein the vertical plane includes first and second opposing sides, wherein the first nozzle member is configured to spray washing liquid from the first side of the vertical plane and the second nozzle member is configured to spray washing liquid from the second side of the vertical plane.

5. The flame arrestor washing assembly of claim 4 wherein the first nozzle member defines a first exit conduit in liquid communication with the conduit member, wherein the first exit conduit defines a first exit axis, wherein the second nozzle member defines a second exit conduit in liquid communication with the conduit member, wherein the second exit conduit defines a second exit axis, wherein the first exit access defines a first orientation angle with the first side of the vertical plane, wherein the first orientation angle is between about 25° and about 35°, wherein the second exit access defines a second orientation angle with the second side of the vertical plane, wherein the second orientation angle is between about 25° and about 35°.

6. The flame arrestor washing assembly of claim 5 wherein the first nozzle member defines a first spray angle that is between about 40° and about 60°, and wherein the second nozzle member defines a second spray angle that is between about 40° and about 60°.

7. The flame arrestor washing assembly of claim 3 wherein the lid includes a liquid opening defined therein, wherein a washing liquid path is defined from the source of washing liquid through the liquid opening in the lid and into the conduit member.

8. A method of cleaning a flame arrestor, the method comprising the steps of:
obtaining a flame arrestor washing assembly that includes
a vessel portion that includes a floor, a lid, opposing first and second side walls, a front wall and a rear wall that cooperate to define a vessel interior, wherein the front wall includes a front opening defined therein,
a drawer member that is received in the front opening, wherein the drawer member includes a bottom member having a plurality of drain openings defined therein, and wherein the drawer member is sized to receive a flame arrestor on the bottom member,
a nozzle assembly depending downwardly from a lower surface of the lid, wherein the nozzle assembly is configured to spray washing liquid toward the flame arrestor positioned on the bottom member of the drawer member, and
a source of washing liquid in liquid communication with the nozzle assembly,
moving the drawer member from the closed position to the open position,
placing the flame arrestor on the bottom member,
moving the drawer member from the open position to the closed position,
flowing washing liquid from the source of washing liquid to the nozzle assembly at a first washing liquid pressure and a first washing liquid temperature, wherein the first washing liquid pressure is between about 1500 PSI and about 2000 PSI, wherein the first washing liquid temperature is between about 140° and about 200°, whereby the nozzle assembly rotates and washing liquid is sprayed from the nozzle assembly to the flame arrestor.

9. The method of claim 8 wherein the lid defines a vertically oriented nozzle axis, wherein the nozzle assembly includes a conduit member that is rotatable about the nozzle axis, wherein the conduit member includes at least first and second arms, wherein the first arm includes a first nozzle member and the second arm includes a second nozzle member, and wherein the first and second nozzle members are configured to spray washing liquid toward the flame arrestor positioned on the bottom member of the drawer.

10. The method of claim 9 wherein a vertical plane bifurcates the first and second arms, wherein the vertical plane includes first and second opposing sides, wherein the first nozzle member is configured to spray washing liquid from the first side of the vertical plane and the second nozzle member is configured to spray washing liquid from the second side of the vertical plane.

11. The method of claim 10 wherein the first nozzle member defines a first exit conduit in liquid communication with the conduit member, wherein the first exit conduit defines a first exit axis, wherein the second nozzle member defines a second exit conduit in liquid communication with the conduit member, wherein the second exit conduit defines a second exit axis, wherein the first exit access defines a first orientation angle with the first side of the vertical plane, wherein the first orientation angle is between about 25° and about 35°, wherein the second exit access defines a second orientation angle with the second side of the vertical plane, wherein the second orientation angle is between about 25° and about 35°.

12. The method of claim 11 wherein the first washing liquid pressure is between about 1700 PSI and about 1800 PSI, wherein the first washing liquid temperature is between about 170° and about 190°.

13. The method of claim 12 wherein the first nozzle member defines a first spray angle that is between about 40° and about 60°, and wherein the second nozzle member defines a second spray angle that is between about 40° and about 60°.

14. The method of claim 8 wherein the lid is pivotally connected to at least one of the first and second side walls, front wall or rear wall and is movable between an open position and a closed position.

15. The method of claim 8 wherein the lid includes a liquid opening defined therein, wherein a washing liquid path is defined from the source of washing liquid through the liquid opening in the lid and into the conduit member.

16. A method of cleaning a flame arrestor, the method comprising the steps of:
obtaining a flame arrestor washing assembly that includes
a vessel portion that includes a floor, a lid, opposing first and second side walls, a front wall and a rear wall that cooperate to define a vessel interior, wherein the front wall includes a front opening defined therein, wherein the lid is pivotally connected to at least one of the first and second side walls, front wall or rear wall and is movable between an open position and a closed position, and wherein the lid defines a vertically oriented nozzle axis,
a drawer member that is received in the front opening, wherein the drawer member includes a bottom member having a plurality of drain openings defined therein, and wherein the drawer member is sized to receive a flame arrestor on the bottom member,
a nozzle assembly depending downwardly from a lower surface of the lid, wherein the nozzle assembly includes a conduit member that is rotatable about the nozzle axis, wherein the lid includes a liquid opening defined therein, wherein a washing liquid path is defined from the source of washing liquid through the liquid opening in the lid and into the conduit member, wherein the conduit member includes at least first and second arms, wherein the first arm includes a first nozzle member and the second arm includes a second nozzle member, wherein the first and second nozzle members are configured to spray washing liquid toward the flame arrestor positioned on the bottom member of the drawer, wherein a vertical plane bifurcates the first and second arms, wherein the vertical plane includes first and second opposing sides, wherein the first nozzle member is configured to spray washing liquid from the first side of the vertical plane and the second nozzle member is configured to spray washing liquid from the second side of the vertical plane, wherein the first nozzle member defines a first spray angle that is between about 40° and about 60°, and wherein the second nozzle member defines a second spray angle that is between about 40° and about 60°, wherein the first nozzle member defines a first exit conduit in liquid communication with the conduit member, wherein the first exit conduit defines a first exit axis, wherein the second nozzle member defines a second exit conduit in liquid communication with the conduit member, wherein the second exit conduit defines a second exit axis, wherein the first exit access defines a first orientation angle with the first side of the vertical plane, wherein the first orientation angle is between about 25° and about 35°, wherein the second exit access defines a second orientation angle with the second side of the vertical plane, wherein the second orientation angle is between about 25° and about 35°, and
a source of washing liquid in liquid communication with the nozzle assembly,
moving the drawer member from the closed position to the open position,
placing the flame arrestor on the bottom member,
moving the drawer member from the open position to the closed position,
flowing washing liquid from the source of washing liquid to the nozzle assembly at a first washing liquid pressure and a first washing liquid temperature, wherein the first washing liquid pressure is between about 1700 PSI and about 1800 PSI, wherein the first washing liquid temperature is between about 170° and about 190°, whereby the nozzle assembly rotates and washing liquid is sprayed from the nozzle assembly to the flame arrestor.
